(19) United States
(12) Patent Application Publication
(10) Pub. No.: US 2005/0073639 A1
(43) Pub. Date: Apr. 7, 2005

(54) Heat dissipating structure of liquid crystal display

(76) Inventor: Shin-Tung Pan, Taipei (TW)

Correspondence Address: Silan Corporation, P. O. Box No. 6-57, Junghe, TAIPEI 235, TW

(21) Appl. No.: 10/678,163

(22) Filed: Oct. 6, 2003

(51) Int. Cl. G02F 1/1333

(52) U.S. Cl. 349/161

(57) ABSTRACT

The invention discloses a heat dissipating structure of liquid crystal display (LCD) having excellent heat dissipation effects and disposed behind a backlight module of the LCD, so as to elevate heat dissipation effects of the LCD. The heat dissipating structure includes a backlight module, a housing, an external heat sink and a plurality of heat dissipating units. An aluminum backboard at a rear portion of the backlight module is fastened to the heat dissipating units using a heat guide adhesive, and has at least a heat sink for conducting thermal energy to the housing. Through the external heat sink at the housing of the LCD, a second heat dissipation is carried out to discharge the thermal energy, thereby accomplishing rapid heat dissipation effects.

### BACKGROUND OF THE INVENTION

(a) Field of the Invention

The invention relates to a heat dissipating structure of liquid crystal display (LCD), in that the heat dissipating structure dissipates excessive heat energy produced from operations of the LCD, thereby maintaining the LCD at an optimum operating status. More particularly, the invention relates to a heat dissipating structure adhered to a backlight module and a housing, so as to prevent a control box in the LCD from damages caused by over-heating.

(b) Description of the Prior Art

Liquid crystal displays (LCD) are extensively applied in televisions and personal computers. However, liquid crystals cannot radiate light, and hence an LCD is necessarily disposed with a backlight module for providing a light source. When temperatures produced by the light source exceed powers bearable by a control box and the backlight module in the LCD, malfunctions or damages of devices in the LCD are often resulted. Therefore, it is a vital task as how to reduce operating temperatures of the backlight module without affecting performances of the LCD.

Common heat dissipating structures disposed at LCD's are divided into a number of categories. Referring to FIG. 1 showing a most commonly used heat dissipating structure, the heat dissipating structure comprises a backlight module 1, a housing 3 and a heat dissipating fan 2. The operating principle is that the heat dissipating fan 3 is disposed near heat dissipating openings 4 at the housing 3. Convection of thermal energy produced by operations of the backlight module 1 is accelerated using the heat dissipating fan 2, and the thermal energy is dissipated into air via the heat dissipating openings 4 at the housing 3, thereby enhancing heat dissipation effects. Yet, generation of convection is totally relied on high speed rotations of the heat dissipating fan 2. For instance, suppose the heat dissipating fan 2 is directly disposed at the backlight module 1, forces produced from rotations thereof inevitably influence normal operations of the backlight module 1. Again, suppose the heat dissipating fan 2 is disposed at the housing 3, not only large noises are produced, but also heat dissipation effects are also affected by dust accumulated from static electricity.

### SUMMARY OF THE INVENTION

In the view of the aforesaid drawbacks, the primary object of the invention is to provide a heat dissipating structure of liquid crystal display (LCD), in that the heat dissipating structure enables smoother and faster ventilation within the LCD and eliminates noises produced by a fan, thereby enhancing heat dissipation effects of the LCD.

A structure according to the invention comprises a backlight module, a housing, an external heat sink and a plurality of heat dissipating units. Wherein, the backlight module has a backlight plate joined with the plurality of heat dissipating units. Using principles of thermal conductance, thermal energy produced by the backlight module is conducted to the housing. The housing has a plurality of draining openings and external heat sinks. The drainage openings are for accomplishing air circulation, and the external heat sinks are disposed at a control box in the LCD, so as to quickly dissipate the thermal energy and thereby achieving rapid heat dissipation effects.

### BRIEF DESCRIPTION OF THE DRAWINGS

FIG. 1 shows a conventional heat dissipating structure of a prior art.

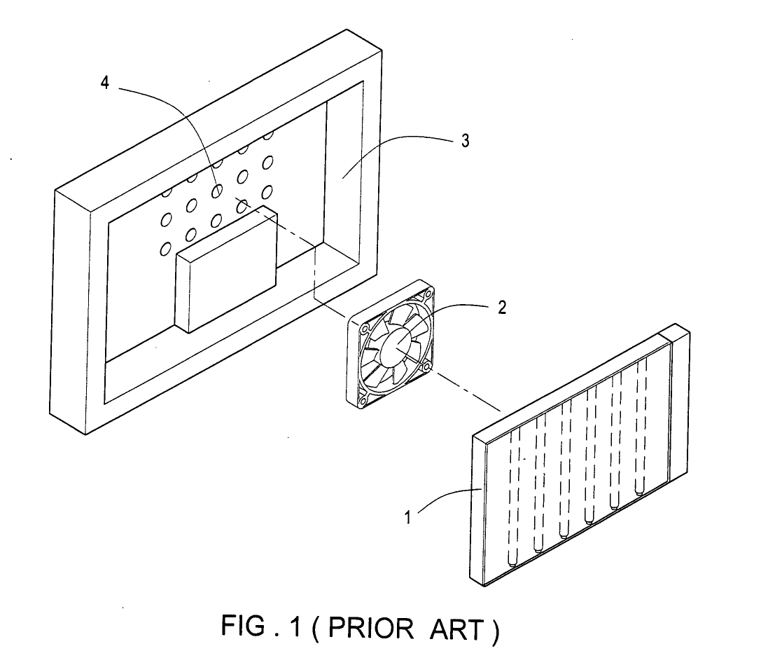

FIG. 2 shows an exploded view of a heat dissipating structure according to the invention.

FIG. 3 shows an exploded view of a backlight module according to the invention.

FIG. 4 shows a sectional view of a liquid crystal display (LCD) according to the invention.

### DETAILED DESCRIPTION OF THE PREFERRED EMBODIMENTS

To better understand the structure, devices and characteristics of the invention, a preferred embodiment shall be given with the accompanying drawings below.

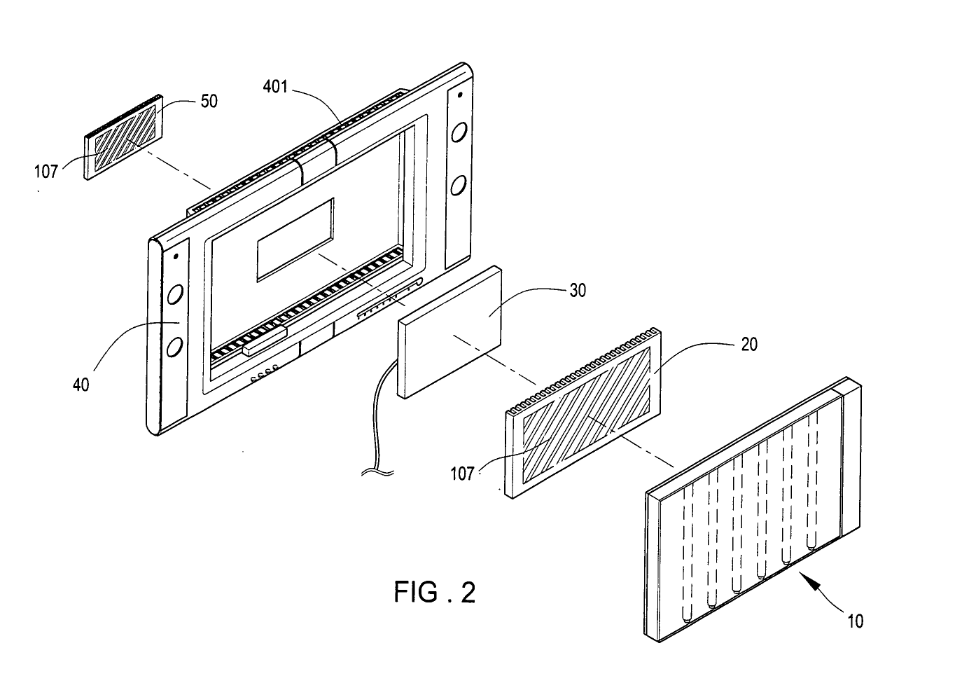

Referring to FIG. 2, a heat dissipating structure according to the invention comprises a backlight module 10, a housing 40, a heat dissipating unit 20, an external heat sink 50 disposed on the housing 40, and a control box 30. The backlight module 10 has a diffuser plate 101, a prism 102, a diffuser board 103, and a plurality of light tubes 104, a reflecting layer 105 and an aluminum backboard 106 at a rear part of the backlight module 10. The reflecting layer 105 having the aluminum backboard 106 adhered to a rear side thereof is joined with the heat dissipating unit 20 using a heat guide adhesive 107. The backlight module 10 is assembled within the housing 40. The housing has a plurality of drainage openings 401. The external heat sink 50 is disposed on the housing 40 using the heat guide adhesive 107. When thermal energy of the backlight module 10 is released via the heat dissipating unit 20, the housing 40 is filled with thermal energy. The thermal energy is then discharged to the housing 40 using the external heat sink 50. Through principles of thermal convection, cold airflows are induced from the drainage openings 401 and thereby accomplishing air circulation.

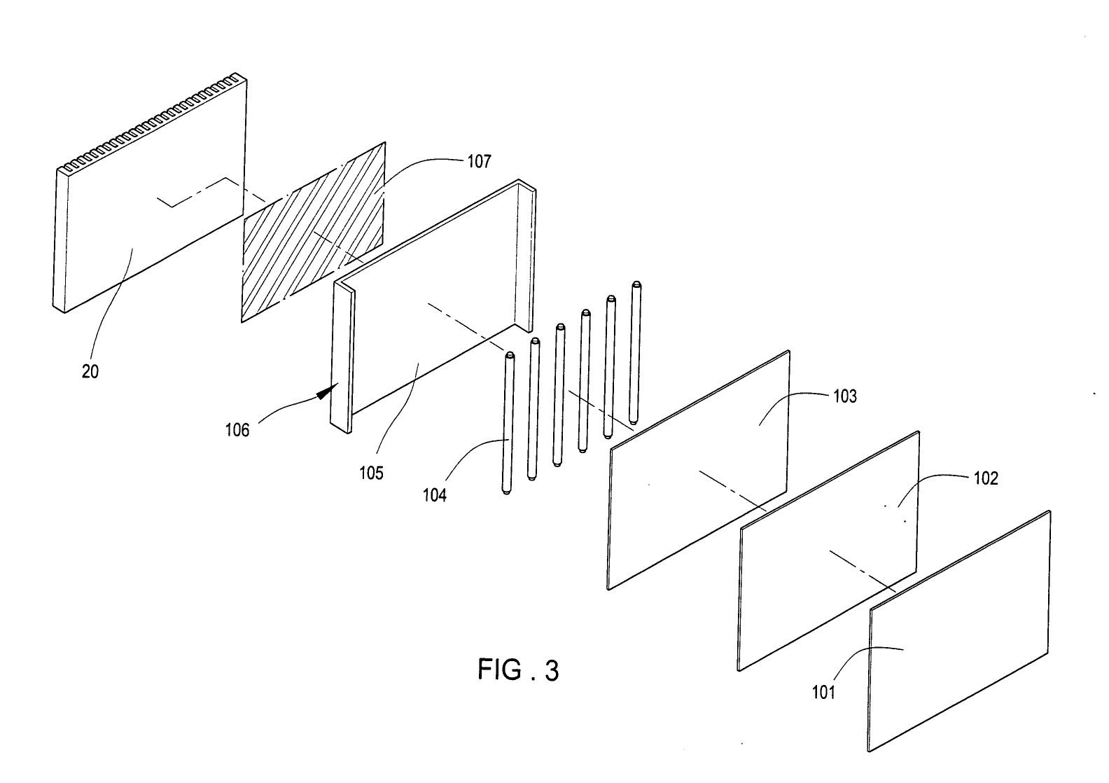

Referring to FIG. 3, a relationship is developed between the backlight module 10 and the heat dissipating unit 20 according to the invention: the light tubes 104 of the backlight module 10 are elements that produce heat; the reflecting layer 105 behind the light tubes 104 has the aluminum backboard 106 at a rear side thereof, and the aluminum backboard 106 conducts the heat source but is incapable of directly dissipating heat. Hence, the aluminum backboard 106 is joined with the plurality of heat dissipating units 20 via the heat guide adhesive 107, so as to quickly dissipate heat.

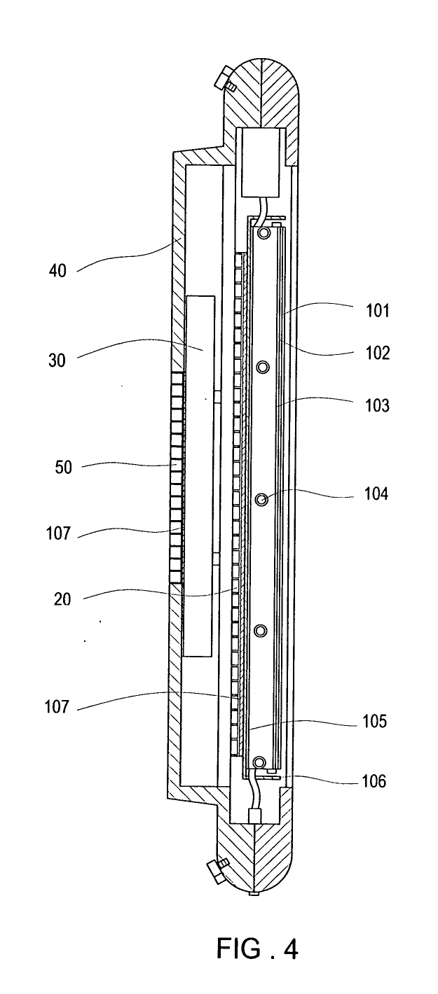

Referring to FIG. 4 showing heat dissipation effects of an assembled LCD according to the invention, each heat dissipating unit 20 has a plane side thereof fastened to the aluminum backboard 106 using the heat guide adhesive 17, and the other side thereof formed in zigzag surfaces for expanding available heat dissipating areas. It is to be noted that the housing 40 has the control box 30 at an interior thereof, and therefore although thermal energy of the backlight module 10 is induced into the housing 40, in order to prevent over-heating and damages of the control box 30, the external heat sink 50 is fastened on the housing 40 using the heat guide 107, and the thermal energy is then guided out of the housing 40 for a second heat dissipation.

The aforesaid heat dissipating units 20 and the external heat sink 50 are made of materials such as aluminum oxide compounds, aluminum nitride and aluminum nitride compounds having high thermal conductance. Each heat dissipating unit 20 and each external heat sink 50 have a planar side thereof fastened to the backlight module 10 and the control box 30, and the other side as a heat dissipating plane in a fin-like, wave-like or a zigzag shape. The heat dissipating units 20 and the heat sinks 50 may be provided in the number of one or more than one. In addition, the external heat sink 50 fastened to the control box 30 may be a formed integral with the housing 40.

Conclusive from the above, in the heat dissipating structure of LCD according to the invention, a plurality of heat dissipating units is disposed at a backlight module. Using principles of thermal conductance, thermal energy produced is conducted to a housing having a plurality of drainage openings and external heat sinks. Wherein, the draining openings are for accomplishing air circulation to reduce noises and maintain heat dissipation effects.

It is of course to be understood that the embodiment described herein is merely illustrative of the principles of the invention and that a wide variety of modifications thereto may be effected by persons skilled in the art without departing from the spirit and scope of the invention as set forth in the following claims.

1. A heat dissipating structure of liquid crystal display (LCD), comprising:
a backlight module having a display panel, a diffuser plate, a plurality of light tubes and a backlight plate; and
a housing joined with the backlight module; and having a control box at an interior thereof, and a plurality of drainage openings;
wherein, a rear side of a reflecting layer is adhered to an aluminum backboard using a heat guide adhesive, the backlight module is disposed with heat dissipating units at a rear portion thereof, and the housing has external heat sinks.

2. The heat dissipating structure of LCD in accordance with claim 1, wherein a heat dissipating plane of each heat dissipating unit is a fin-like shape.

3. The heat dissipating structure of LCD in accordance with claim 1, wherein a heat dissipating plane of each heat dissipating unit is a wave-like shape.

4. The heat dissipating structure of LCD in accordance with claim 1, wherein a heat dissipating plane of each heat dissipating unit is a zigzag shape.

5. The heat dissipating structure of LCD in accordance with claim 1, wherein a heat dissipating plane of each external heat sink is a fin-like shape.

6. The heat dissipating structure of LCD in accordance with claim 1, wherein a heat dissipating plane of each external heat sink is a wave-like shape.

7. The heat dissipating structure of LCD in accordance with claim 1, wherein a heat dissipating plane of each external heat sink is a zigzag shape.

8. The heat dissipating structure of LCD in accordance with claim 1, wherein the external heat sink is a formed integral with the housing.
